(19) United States
(12) Patent Application Publication
(10) Pub. No.: US 2026/0338075 A1
(43) Pub. Date: Oct. 29, 2026

(54) SHIM FOR A TURBINE ENGINE TURBINE DISK, ASSEMBLY FOR A TURBINE ENGINE ROTOR, TURBINE ENGINE ROTOR, TURBINE ENGINE, AND METHOD FOR INSTALLING AN ASSEMBLY FOR A TURBINE ENGINE ROTOR

(71) Applicant: SAFRAN AIRCRAFT ENGINES, PARIS (FR)

(72) Inventor: Kim Long Johan DO KHAC-VERHERTBRUGGEN, MOISSY-CRAMAYEL (FR)

(21) Appl. No.: 19/107,932

(22) PCT Filed: Sep. 1, 2023
(86) PCT No.: PCT/FR2023/051320

§ 371 Date: Feb. 28, 2025

(30) Foreign Application Priority Data
Sep. 1, 2022 (FR) 2208784

(51) Int. Cl. F01D 5/30

(52) U.S. Cl. CPC F01D 5/30; F05D 2230/60

(57) ABSTRACT

A shim for a turbine engine turbine disc, includes a metal sheet forming an envelope that at least partially surrounds a tooth of the turbine disc, the tooth separating a first and a second cavity of the disc, each cavity being adapted to receive a root of a movable blade of the turbine. The envelope is adapted to at least partially cover each of the side walls of the tooth, and a downstream rim of the tooth.

### TECHNICAL FIELD OF THE INVENTION

This invention relates to a foil for a turbomachine turbine disk. It also relates to an assembly for a rotor including such a foil mounted around a tooth of the disk. It further relates to a method for mounting this assembly.

The invention finds applications in the field of aeronautics and, in particular, in the field of turbomachine rotors to protect both the vane root and the rim of the disk and increase the service life of rotors.

### TECHNOLOGICAL BACKGROUND OF THE INVENTION

In aeronautics, it is known that a rotor vane 10, an example of which is represented in FIG. 1, comprises a blade 12 fitted, in the lower part, with a platform 11 from which a root 20 radially extends, which root is to be inserted into a cavity formed in the outer periphery of a disk of the rotor. The root 20 of the vane 10 of the rotor—also called the movable vane—is radially retained in the cavity of the disk by shape cooperation between said root, which is generally dovetail-shaped, and the cavity, which is generally cell-shaped. In the upper part, the blade 12 is fitted with a shroud 13 to be disposed edge to edge with the shroud of the adjacent movable vanes so as to form a rotating circumferential ring delimiting a surface of revolution about the axis of rotation X of the disk.

During operation of the rotor, contact between the roots of the movable vanes (more simply called vane roots), which are for example made of titanium aluminide, and the disk, which is for example made of a nickel-based alloy, leads to premature wear of the vane roots and/or the cavities of the disk.

In order to limit wear on the vane roots and the cavities of the disk, it is known to place a contact piece 30, called a foil, at the contact interfaces, commonly called seats or bearing, between the vane roots and the cavities of the disk. Conventionally, the foil is a foil for a movable vane, mounted around the root 20 of said movable vane. This foil, referenced as 30, is in contact with the disk and absorbs most of the energy dissipated by friction in the contact between the root of the movable vane and the disk, thereby limiting wear of said vane root.

FIG. 2 represents an enlarged view of the root 20 of the movable vane 10 of FIG. 1, around which a conventional foil 30 is mounted. This foil 30 includes an overall U-shaped cross-section, formed by two side branches 32, or side surfaces (only one of which is visible in FIG. 2), to cover the side flanks 22 of the root 20 of the movable vane 10 and to hold the foil 30 on the vane root 20. The foil 30 also includes a base 31, also called the lower surface, which connects the side surfaces 32 together and covers the lower face 21 of the vane root 20.

The foil 30 therefore has a function of protecting the vane root and the cavity of the disk by preventing wear of these pieces. It thus guarantees the mechanical integrity of the pieces (vane root and disk) with which it is in contact.

In order to prevent the foil 30 from disengaging from the vane root 20, the lower surface 31 of the foil generally comprises radial tabs 33 bearing against the upstream 23 and downstream 24 faces of the root 20. The radial tabs 33 (only one of which is visible in FIG. 2) are strips cut out at the end of the lower surface 31 and radially folded down along the upstream and downstream faces 23, 24 of the vane root 20. These radial tabs 33 extend over a greater or lesser width, between the side branches 32 of the foil, and form stops which make it possible to prevent relative axial movements between the vane root 20 and the foil 30.

However, despite the presence of the radial tabs 33, turbomachine maintenance operators have noticed that the foils tend to move axially, which damages and even severs the radial tabs 33. Indeed, as a result of being radially folded during the manufacturing phase and/or unfolded during the mounting phase, the radial tabs are weakened and the friction generated by the repeated axial movement of the foils has the effect of severing or breaking them. Once the radial tabs are broken, the foils 30 can disengage partially or even completely from the vane roots 20, as represented in FIG. 3.

Disengagement of one (or more) foils 30 can cause the foil to be released into the air stream of the turbomachine and damage the vanes located downstream of the Low Pressure Turbine, and especially the titanium aluminide (TiAl) based vanes which are particularly sensitive to shocks. Disengagement of a foil 30 can also lead to greater wear between the vane root 20 and the disk 40 since the protective piece is no longer present and, consequently, degraded mechanical strength of these pieces in the zone.

This phenomenon of disengagement of the foils is initiated and sustained by two factors which combine:
the mechanical strength of the foil which is insufficient and does not withstand the stresses generated between the vane root and the disk during operation, and
the thermal loads generated by the sequence of thermal expansions/contractions undergone by the vane root and the disk over the operating cycles. Indeed, as the temperature of the vane root successively rises and falls, the foil also expands and contracts, leading to damage and partial and then total degradation.

In maintenance, disengagement of one or more foils leads to the removal of the rotor for repair. Yet, removal and repair of a rotor involves considerable costs in terms of pieces and labour, as well as downtime of the turbomachine.

Besides, it has been noticed that there is unfortunate wear of the rim of the disk on the downstream face of the teeth of the disk. Indeed, the downstream axial stop of the vane root 20 is generally achieved by means of a retaining ring inserted into a hook on the vane. A cross-section view of a vane root 20 mounted into a cavity 41 of the disk 40 is represented in FIG. 4. This view of FIG. 4 shows the disk 40 in which the root 20 of the movable vane 10 is housed. It also shows the hook 15 of the movable vane 10, projecting on the downstream face, into which a retaining piece called a retaining ring 50 is slid. The retaining ring 50 extends circularly along the downstream face of the disk 40 so as to retain all the vane roots 20 in the cavities of the disk and prevent any axial downstream movement of said vane roots.

The retaining ring 50 is therefore in contact, not only with the downstream face of the vane roots 20, but also with the downstream rim 46 of the disk 40, at the teeth of the disk. This contact between the retaining ring 50 and the downstream rim of the teeth of the disk generates fretting zones 48, as represented in FIG. 5. Each fretting zone 48 induces a risk of initiation and propagation of cracks which have a real impact on the service life of the disk. In maintenance, a crack initiated by fretting leads to premature removal of the disk, followed by repair or replacement of the disk. Yet, removal and repair or replacement of the disk involves significant costs in terms of pieces and labour, as well as downtime of the turbomachine.

### SUMMARY OF THE INVENTION

In order to respond to the problems discussed above of disengagement of movable vane foils and fretting of the rim of the disk, the applicant provides a foil for a turbine disk, positioned at least partly around a tooth of the disk and extending, on the one hand, along the rim of the disk and, on the other hand, between the side wall of the cavity of the disk and the root of the movable vane.

According to a first aspect, the invention relates to a foil for a turbomachine turbine disk, comprising a casing at least partially surrounding a tooth of the turbine disk, said tooth separating a first and a second cavity of the disk, each adapted to receive a root of a movable vane of the turbine, characterised in that the casing is adapted to at least partially cover side walls of the tooth and a downstream rim of said tooth.

The foil according to the invention has the advantage of protecting not only the contact zone between the vane root and the cavity of the disk but also the contact zone between the retaining ring and the rim of the disk. It also avoids the risk of disengagement of the foil.

The use of a foil according to the invention, in a turbomachine, makes it possible to limit the number of engine removals, to reduce the number of pieces to be changed during an engine removal and, therefore, to reduce the maintenance costs of the turbomachine. It also makes it possible to extend the service life of the turbine and improve flight safety.

In the present application, the terms “lower”, “upper”, “inner” and “outer” are interpreted with reference to the position of a piece or surface relative to the axis of rotation of the turbomachine, a lower or inner surface being closer to the axis of rotation than an outer or external surface. The term “side” is interpreted as “which is located on the sides of a piece which radially extends” along an axis substantially perpendicular to the axis of rotation X. The term “axial” is to be interpreted as “in the direction of the axis of rotation” and the term “radial” as “in a direction perpendicular to the axis of rotation” or “in the direction of a radius of the vane ring”. The terms “upstream” and “downstream” will be interpreted with reference to the direction of flow of the airflow in the turbomachine.

Further to the characteristics just discussed in the preceding paragraph, the foil for a turbine disk according to one aspect of the invention may have one or more complementary characteristics from among the following, considered individually or according to any technically possible combinations:
According to one example, the foil completely covers a part of the downstream rim of the tooth circumferentially, the part of the downstream rim of the tooth being radially delimited between the apex of the tooth and a tangent line whose plane parallel to the axis x passes through the ends of the seats of the tooth opposite to the apex.
According to one example, the foil comprises two side longitudinal edges each extending into a zone covered by a main surface adapted to cover an outer face of the tooth of the disk. According to one example, the two side longitudinal edges are parallel and are remote from each other by a distance less than the circumferential width of the main surface. The two side longitudinal edges connect an outer surface of the foil and an inner surface of the foil adapted to face the tooth.
it includes a main surface adapted to cover an outer face of the tooth of the disk, a first and a second side surface extending from the main surface to cover side walls of the tooth of the disk, and a downstream surface extending between the main surface and the side surfaces to at least partially cover a downstream rim of the tooth of the disk.
it includes at least one tab radially extending along an upstream rim of the tooth of the disk.
it includes two tabs radially extending along the upstream rim of the tooth of the disk and distributed along said upstream rim.
the tab(s) is/are formed as an extension of the main surface and folded along the upstream rim.
It includes a substantially C-shaped cross-section, with a main body of the C covering the outer face of the tooth of the disk and two arms of the C covering the side walls of the tooth of the disk.
the casing is formed from a metal sheet.

A second aspect of the invention relates to an assembly for a turbomachine rotor, including:
at least a first and a second movable vane configured to be rotatably movable about an axis of rotation of the rotor and each including a vane root fitted with a lower face and two side flanks extending on either side of the lower face,
a disk including at least
   a first and a second cavity each adapted to receive a vane root, and
   a tooth separating the first and the second cavity, and
a foil according to one aspect of the invention.

Advantageously, the first side surface of the foil is housed between one of the side walls of the tooth of the disk and the side flank of the vane root of the first movable vane and, the second side surface of the foil is housed between another of the side walls of the tooth of the disk and the side flank of the vane root of the second movable vane.

A third aspect of the invention relates to a method for mounting a rotor assembly for a turbomachine according to the second aspect. This method is characterised in that it includes the following steps of:
positioning a foil according to the first aspect of the invention around a tooth of the disk so that said foil covers at least the side walls and the downstream rim of the tooth of the disk,
folding at least one tab so as to position it along the upstream rim of the tooth of the disk, and
installing the first vane root into the first cavity of the disk and the second vane root into the second cavity so that a portion of the foil is positioned between the first vane root and one of the side walls of the tooth of the disk and another portion of the foil is positioned between the second vane root and the other side wall of the tooth of the disk.

A fourth aspect of the invention relates to a turbomachine rotor, characterised in that it includes a plurality of assemblies as defined above, juxtaposed circularly next to one another.

A fifth aspect of the invention relates to a turbomachine, characterised in that it includes a plurality of assemblies as defined above, mounted so as to form a rotor.

### BRIEF DESCRIPTION OF THE FIGURES

Further advantages and characteristics of the invention will become apparent upon reading the following description, illustrated by the figures in which:

FIG. 1, already described, represents a schematic perspective view of a turbomachine movable vane according to the state of the art;

FIG. 2, already described, represents a schematic perspective view of a movable vane root equipped with a foil according to the state of the art;

FIG. 3, already described, schematically represents a perspective view of a broken foil, in the process of disengaging from the vane root;

FIG. 4, already described, schematically represents a radial cross-section view of a vane root mounted into a disk cavity and held in place by a retaining ring;

FIG. 5, already described, schematically represents a perspective view of a portion of a disk rim prematurely worn by contact with a retaining ring;

FIG. 6 schematically represents a perspective view of a disk tooth equipped with a foil according to one embodiment of the invention when a vane root is mounted into the cavity adjacent to the tooth;

FIG. 7 schematically represents a perspective view of a foil for a turbine disk according to a preferred embodiment of the invention;

FIG. 8 schematically represents a perspective view, from upstream, of a foil according to one embodiment of the invention, mounted to a tooth of a turbine disk; and

FIG. 9 schematically represents a perspective view, from downstream, of a foil according to one embodiment of the invention, mounted to a tooth of a turbine disk.

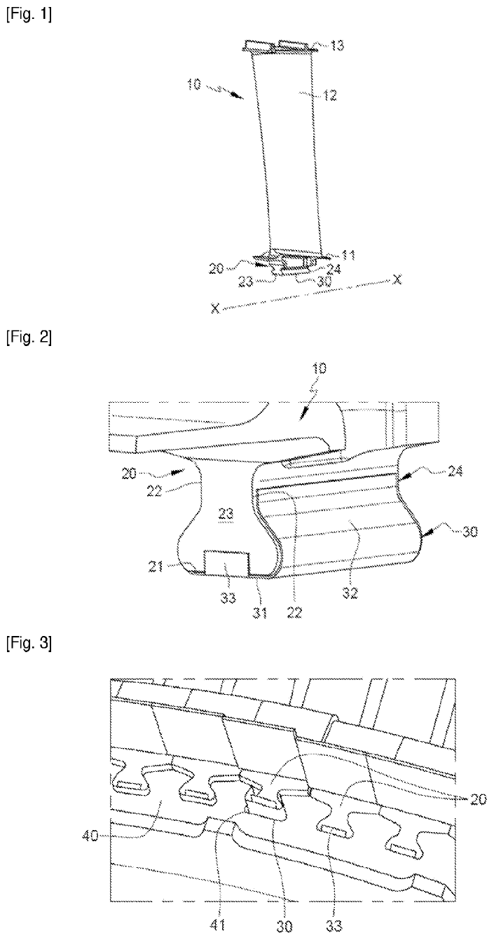

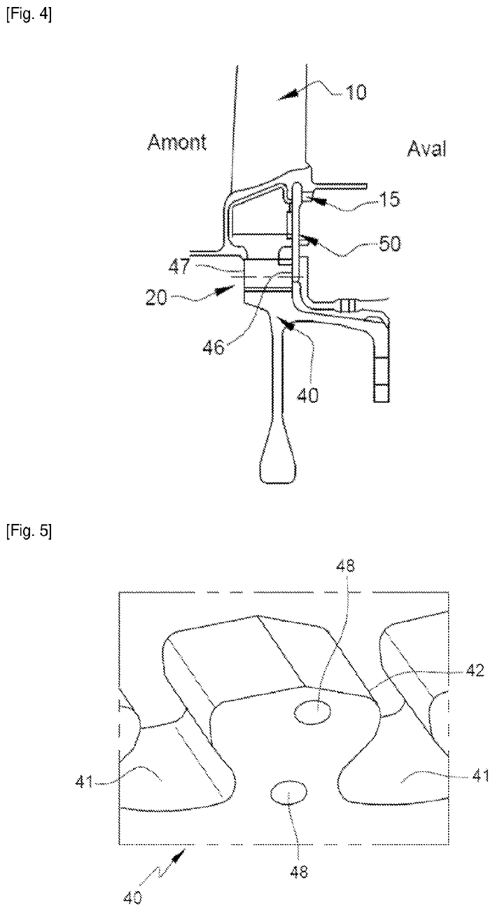

### DETAILED DESCRIPTION

An exemplary embodiment of a foil for a turbine disk, configured both to protect the rim of the disk and to protect the vane root without risk of disengagement, is described in detail hereinafter, with reference to the appended drawings. This example illustrates the characteristics and advantages of the invention. However, it is reminded that the invention is not limited to this example.

In the figures, identical elements are identified by identical references. For reasons of legibility, the size scales between the elements represented are not respected.

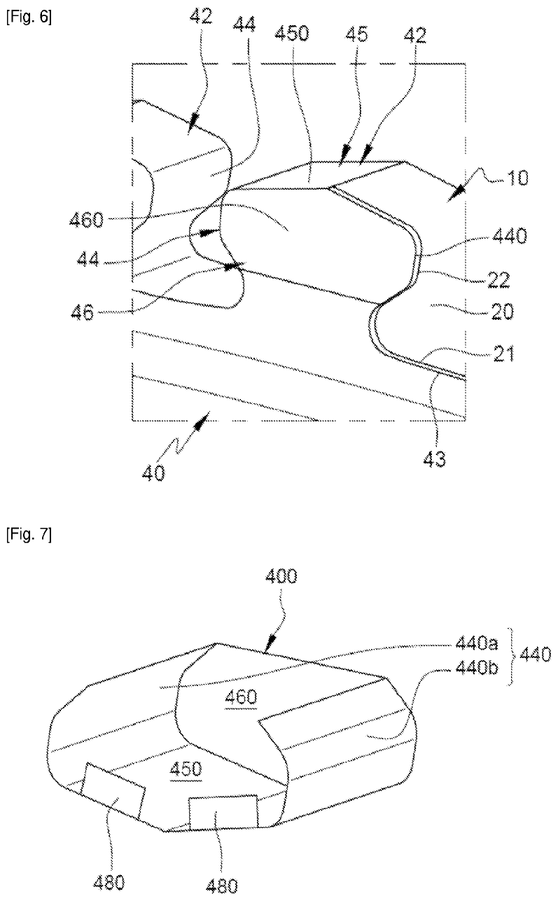

A turbomachine rotor includes a disk and a plurality of movable vanes, each retained in a cavity in the disk by its root. The root of each vane is housed in a cavity in the disk. An example of a disk cavity is represented in perspective in FIG. 6. Each cell-shaped cavity 41 (not referenced in FIG. 6 but visible) of the disk 40, is generally provided in the outer periphery of the disk 40. Each cavity 41 is separated from a neighbouring cavity by a tooth 42 of the disk. A dovetail-shaped root 20 of a movable vane 10 (partially represented in FIG. 6 by only a surface facing a tooth to enable the tooth to be seen three-dimensionally) of the rotor, is engaged in each cavity 41 and is radially held in said cavity by shape cooperation between the root and the cavity.

A cavity 41 of the disk 40 includes a bottom surface 43 and two side surfaces, each formed by the side wall 44 of an adjacent tooth 42. A tooth 42 of the disk 40 therefore includes two side walls 44 as well as an outer face 45, a downstream rim 46 and an upstream rim 47 (not visible in FIG. 6). The downstream rim 46 and upstream rim 47 are also referred to as the downstream or upstream radial surface of the tooth respectively.

Each vane root 20 comprises a lower face 21, facing the bottom surface 43 of the cavity 41, and two side flanks 22 forming the contact interfaces of the vane root 20 with the disk cavity 41.

When the rotor is rotated, the movable vanes are subjected to centrifugal forces; under the effect of these centrifugal forces, the side flanks 22 of the vane roots 20 come in a stop position against the side walls 44 of the teeth 42 of the disk 41 (or side surfaces of the cavity 41). According to the invention, a foil 400, made from a metal sheet (metal or alloy), is positioned around each tooth 42 of the disk 40 so as to envelop at least the zones to be protected. Thus, each foil 400 preferably covers at least the side walls 44 of the tooth 42 with which it is associated, as well as the downstream rim 46 of said tooth 42.

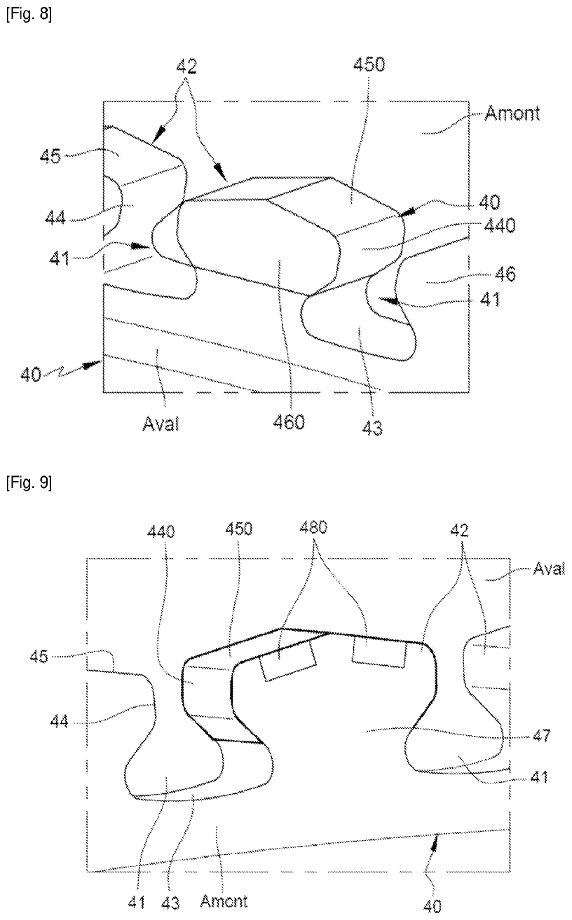

An example of a foil 400 according to a preferred embodiment is represented in FIG. 7. An example of this foil 400 mounted to a tooth 42 of the disk 40 is represented in FIG. 8 in a perspective view from downstream. The foil 400 according to this preferred embodiment includes:
a main surface 450 adapted to cover the outer face 45 of the tooth 42,
a first and a second side surface 440 to cover the side walls 44 of the tooth 42, and
a downstream surface 460 to at least partially cover the downstream rim 46 of the tooth 42 of the disk.

The main surface 450 and the side surfaces 440 extend as an extension of each other, a first side surface 440a extending from one side of the main surface 450, a second side surface 440b extending from the other side of the main surface, opposite to the first side surface. The main surface 450 and the side surfaces 440 have a C-shaped cross-section, the main body of the C being formed by the main surface 450, the two arms of the C being formed by the two side surfaces 440a, 440b.

The downstream surface 460 radially extends along the downstream rim 46 of the tooth 42, between the two side surfaces 440a, 440b and the main surface 450 so that the assembly (main, side and upstream surfaces) has an overall hood shape.

Thus, with such a shape of the foil 400, each side flank 22 of a vane root 20 is separated from the side wall 44 of the adjacent tooth 42 (or side surface of the cavity 41) by a side surface 440 of the foil 400. In other words, the first side surface 440a of the foil 400 is positioned between the side flank 22 of one vane root 20 and one of the side walls 44 of the tooth 42, and the second side surface 440b of the foil 400 is positioned between the side flank 22 of another vane root 20 and the other side wall 44 of the tooth 42 of the disk 40 so that the two side walls of the tooth 42 and the side flank 22 of each of the adjacent vane roots are protected from friction by contact with one another.

With the shape of the foil 400 described previously, the downstream rim 46 of the tooth 42 of the disk is covered by the downstream surface 460 of the foil 400. Thus, the downstream rim 46 is not in direct contact with the retaining ring 50 allowing the vane root 20 to be axially stopped in the downstream direction, so that said downstream rim 46 is protected from risks of friction by contact with said ring.

In one embodiment of the invention, the foil 400 includes at least one tab 480 radially extending along the upstream rim 47 of the tooth 42 of the disk to lock the positioning of said foil around the tooth 42. An example of this embodiment is represented in FIG. 9 in a perspective view from upstream. The tab 480 is formed from the same metal sheet as all the foil 400, by cutting said sheet. The tab 480 extends from the end of one of the surfaces of the foil 400, for example from the main surface 450 or from one of the side surfaces 440, and is folded back along the rim 47 of the tooth 42. In the example of FIG. 9, the tab 480 extends as an extension of the main surface 450. When folded back, the tab 480 extends in a radial plane against the upstream rim 47, ensuring that the foil 400 is axially held around the tooth 42.

According to some embodiments, the foil 400 includes several tabs 480, for example two as in the example of FIG. 9, all folded back along the upstream rim 47. When there are several tabs 480, these are preferably distributed around the contour of the upstream rim 47 in order to optimise holding of the foil around the tooth 42.

The foil 400 as described previously is made, for example, by folding or drawing a metal sheet. The tab or tabs are made by cutting the metal sheet. They are folded only once the foil has been correctly positioned on the tooth 42 of the disk.

Indeed, once the foil 400 has been manufactured, it is mounted to the tooth 42 of the disk by sliding along the outer face 45 and the side walls 44 of said tooth, from downstream to upstream. In other words, the foil 400 is axially slipped around a tooth 42 of the disk. It is in position when its downstream surface 460 is in contact with the downstream face 46 of the tooth 42. The foil 400 then covers the side walls 44, the outer face 45 and the downstream face 46 of the tooth 42 of the disk. When present, the tabs 480 are then radially folded down along the upstream face 47 of the tooth 42 so as to block the foil around the tooth 42. Two vane roots 20 can then each be installed into one of the cavities 41 adjacent to the tooth 42. The side surfaces 480a, 480b of the foil 400 are then each positioned in a cavity 41, between one of the vane roots and one of the side walls 44 of the tooth 42.

It is understood from the above that, unlike the foils of the state of the art, the foil 400 according to the invention is mounted to the disk, around a disk tooth, and not around the vane root. This mounting enables the mechanical strength of the foil to be improved without deforming or weakening it. It further protects the downstream rim of the disk, in addition to the contact zone between the vane root and the wall of the cavity 41 of the disk.

More generally, the foil 400 enables reduced costs by improving the durability of rotor pieces, avoiding potential engine removal due to premature fretting, reducing the number of pieces changed during engine removal, and reducing maintenance costs and the number of servicing operations. It thus improves customer satisfaction and eliminates a recurring problem.

Although described through a number of examples, alternatives and embodiments, the foil for a turbine disk and the assembly for a rotor according to the invention comprise various alternatives, modifications and improvements which will be obvious to the person skilled in the art, it being understood that these alternatives, modifications and improvements are within the scope of the invention.

1. A foil for a turbomachine turbine disk, comprising a casing at least partially surrounding a tooth of a turbine disk, said tooth separating a first and a second cavity of the disk, each adapted to receive a root of a movable vane of the turbine, wherein the casing is adapted to at least partially cover:
each of the side walls of the tooth,
a downstream rim of said tooth.

2. The foil according to claim 1, comprising:
a main surface adapted to cover an outer face of the tooth of the disk,
a first and a second side surface extending from the main surface to cover side walls of the tooth of the disk, and
a downstream surface extending between the main surface and the side surfaces to at least partially cover a downstream rim) of the tooth of the disk.

3. The foil according to claim 1, comprising a tab radially extending along an upstream rim of the tooth of the disk.

4. The foil according to claim 2, comprising at least two tabs radially extending along the upstream rim of the tooth of the disk and distributed along said upstream rim.

5. The foil according to claim 2, wherein the tab is formed as an extension of the main surface and folded along the upstream rim.

6. The foil according to claim 1, comprising a substantially C-shaped cross-section, with a main body of the C which covers the outer face of the tooth of the disk and two arms of the C which cover the side walls of the tooth of the disk.

7. The foil according to claim 1, wherein the casing is formed from a metal sheet.

8. An assembly for a turbomachine rotor comprising:
at least a first and a second movable vane configured to be rotatably movable about an axis of rotation of the rotor and each including a vane root provided with a lower face and two side flanks extending on either side of the lower face,
a disk including at least
a first and a second cavity each adapted to receive a vane root and
a tooth separating the first and the second cavity, and
a foil according to claim 1.

9. The assembly according to claim 8, wherein the first side surface of the foil is housed between one of the side walls of the tooth of the disk and the side flank of the vane root of the first movable vane and the second side surface of the foil is housed between another of the side walls of the tooth of the disk and the side flank of the vane root of the second movable vane.

10. A method for mounting a rotor assembly for a turbomachine according to claim 8, comprising:
positioning a foil according to claim 1, around a tooth of the disk so that said foil covers at least the side walls and the downstream rim of the tooth of the disk,
folding at least one tab so as to position it the at least one tab along the upstream rim of the tooth of the disk, and
installing the root of the first movable vane into the first cavity of the disk and the root of the second movable vane into the second cavity so that a portion of the foil is positioned between the root of the first movable vane and one of the side walls of the tooth of the disk and another portion of the foil is positioned between the root of the second movable vane and the other side wall of the tooth of the disk.

11. A turbomachine rotor, comprising a plurality of assemblies according to claim 8, juxtaposed circularly next to one another.

12. The turbomachine, comprising a plurality of assemblies according to claim 8 mounted so as to form a rotor.
